(19) United States
(12) Patent Application Publication
(10) Pub. No.: US 2009/0016529 A1
(43) Pub. Date: Jan. 15, 2009

(54) METHOD AND SYSTEM FOR PREVENTION OF UNAUTHORIZED COMMUNICATION OVER 802.11W AND RELATED WIRELESS PROTOCOLS

(75) Inventors: K. N. Gopinath, Pune (IN); Amit Vartak, Pune (IN); Md Sohail Ahmad, Pune (IN); Murthy Jonnalagadda, Pune (IN)

Correspondence Address: AIRTIGHT NETWORKS, 339 N. BERNARDO AVENUE, SUITE 200, MOUNTAIN VIEW, CA, 94043, US

(73) Assignee: AIRTIGHT NETWORKS, INC., Mountain View, CA (US)

(21) Appl. No.: 11/775,869

(22) Filed: Jul. 11, 2007

(51) Int. Cl. H04K 1/00; H04L 9/32; H04Q 7/24

(52) U.S. Cl. 380/270; 370/338; 726/3

(57) ABSTRACT

A method for disrupting undesirable wireless communication in wireless network is provided. The method includes providing one or more sniffer devices to monitor wireless communications in a wireless network and detecting a wireless connection established between an access point device and a client device using the one or more sniffer devices. Preferably, the wireless connection is configured for not being disconnected upon receiving a spoofed disconnection request transmitted from a wireless device other than the access point device and the client device. The method also includes disrupting the wireless connection established between the access point device and the client device by transmitting one or more spoofed connection requests from at least one of the one or more sniffer devices.

### BACKGROUND OF THE INVENTION

Computer systems have proliferated from academic and specialized science applications to day-to-day business, commerce, information distribution and home applications. Such systems can include personal computers (PCs) to large mainframe and server class computers. Powerful mainframe and server class computers run specialized applications for banks, small and large companies, e-commerce vendors, and governments. Personal computers can be found in many offices, homes, and even local coffee shops.

The computer systems located within a specific local geographic region (e.g., an office, building floor, building, home, or any other defined indoor and/or outdoor geographic region) are typically interconnected using a Local Area Network (LAN) (e.g., the Ethernet). The LANs, in turn, can be interconnected with each other using a Wide Area Network (WAN) (e.g., the Internet). A conventional LAN can be deployed using an Ethernet-based infrastructure comprising cables, hubs switches, and other elements.

Connection ports (e.g., Ethernet ports) can be used to couple multiple computer systems to the LAN. For example, a user can connect to the LAN by physically attaching a computing device (e.g., a laptop, desktop, or handheld computer) to one of the connection ports using physical wires or cables. Other types of computer systems, such as database computers, server computers, routers, and Internet gateways, can be connected to the LAN in a similar manner. Once physically connected to the LAN, a variety of services can be accessed and/or provided by these computers (e.g., file transfer, remote login, email, WWW, database access, and voice over IP).

Using recent (and increasingly popular) wireless technologies, users can now be wirelessly connected to the computer network. Thus, wireless communication can provide wireless access to a LAN in the office, home, public hot-spot, and other geographical locations. The IEEE 802.11 family of standards (also called Wireless Local Area Network, WLAN or WiFi) are popular for such wireless communication. In WiFi, the 802.11b standard provides for wireless connectivity at speeds up to 11 Mbps in the 2.4 GHz radio frequency spectrum; the 802.11g standard provides for even faster connectivity up to about 54 Mbps in the 2.4 GHz radio frequency spectrum; and the 802.11a standard provides for wireless connectivity at speeds up to about 54 Mbps in the 5 GHz radio frequency spectrum. Wireless communication standards that offer even higher data rates such AS 802.11n and/or operate in different frequency spectrums such as 802.16 are also possible.

Advantageously, WiFi can facilitate a quick and effective way of providing wireless extension to existing LAN. To provide this wireless extension, one or more WiFi access points (APs) can connect to the connection ports either directly or through intermediate equipment, such as WiFi switch. After an AP is connected to a connection port, a user can access the LAN using a device (called a “station” or a “client”) equipped with WiFi radio. Examples of the devices equipped with WiFi radio include but not limited to laptop computers, personal digital assistants (PDAs), handheld scanners, fixed computers etc. The station can wirelessly communicate with the AP and the AP can transfer information between wired and wireless portions of the LAN.

WiFi uses radio signals for information transfer. Since wireless signals cannot be confined to physical boundaries of premises, they often cause a concern to the owner of the wireless computer network. In particular the owners are concerned about spillage of wireless signals from the computer network into outside of the premises (e.g., home, office, building, campus etc.) as the spillage of signals can be used for unauthorized access to the wireless computer network. For example, unauthorized wireless clients (e.g., neighbor's clients or other clients in parking lot, street etc.) can access the computer network using this spillage. Also authorized clients can accidentally or deliberately attempt connection to external (e.g., neighbor's) computer networks using radio spillage of those networks. It is also common to find wireless APs connected to the LAN by employees without the knowledge of administrator. Whether such action is inadvertent or malicious, such APs may not employ the correct security controls and hence their signal spillage may provide easy avenue for hackers outside the LAN premises to gain unauthorized access to the LAN. Therefore a need arises to improve security of wireless computer networks.

### BRIEF SUMMARY OF THE INVENTION

According to the present invention, techniques directed to wireless computer networking are provided. More particularly, the present invention provides methods and systems for enhancing security of wireless networking environments characterized by the IEEE 802.11w and related protocols, and their variants.

According to an embodiment of the present invention, a method for disrupting undesirable wireless communication in wireless network is provided. The method includes providing one or more sniffer devices to monitor wireless communications in a wireless network and detecting a wireless connection established between an access point device and a client device using the one or more sniffer devices. Preferably, the wireless connection is configured for not being disconnected upon receiving a spoofed disconnection request transmitted from a wireless device other than the access point device and the client device. The method also includes disrupting the wireless connection established between the access point device and the client device by transmitting one or more spoofed connection requests from at least one of the one or more sniffer devices.

According to an alternative embodiment of the present invention, a method for disrupting undesirable wireless communication in wireless network is provided. The method includes providing one or more sniffer devices that are spatially disposed over a geographic region associated with the wireless network to monitor wireless communications in the wireless network. The method includes receiving information associated with an undesirable wireless link between an access point device and a client device at at least one of the one or more sniffer devices. This information includes wireless MAC addresses of the access point device and the client device, respectively. The method includes driving the undesirable wireless link in a state of deadlock by transmitting one or more spoofed connection requests from at least one of the one or more sniffer devices. Moreover, the one or more spoofed connection requests are transmitted while the undesirable wireless link is in a state of being connected. Each of the one or more spoofed connection requests includes the wireless MAC address of the client device as originator identity and the wireless MAC address of the access point device as destination identity.

According to yet alternative embodiment of the present invention an apparatus for disrupting undesirable wireless communication is provided. The apparatus includes a memory module. The memory module comprises one or more electronic memory devices. The memory module stores one or more first codes for receiving information associated with a wireless connection established between an access point device and a client device in a wireless network. This information includes wireless MAC addresses of the access point device and the client device, respectively. The memory module also stores one or more second codes for receiving instruction for disrupting the wireless connection established between the access point device and the client device. Moreover, the memory module stores one or more third codes for formatting one or more connection requests. Each of the one or more connection requests includes the wireless MAC address of the client device as originator identity and the wireless MAC address of the access point device as destination identity. The apparatus includes a processor module comprising one or more micro processing devices. The processor module being for executing at least the first, the second, and the third codes. The apparatus also includes a transmitter module including one or more wireless communication transmitting interfaces for transmitting the one or more connection requests to disrupt the wireless connection established between the access point device and the client device.

Depending upon the embodiment, various advantages and/or benefits can be achieved by practicing the present invention. In an embodiment, the present invention provides a security monitoring system and associated methods to enhance the security of the wireless networking environments. In an alternative embodiment, the present invention can disrupt undesirable wireless links that are free from disruption by conventional deauthentication and/or disassociation based denial of service (DOS) techniques. These and other advantages and benefits will be apparent throughout the present specification and more particularly below.

### BRIEF DESCRIPTION OF THE DRAWINGS

FIG. 1 shows an exemplary LAN architecture that supports wireless intrusion prevention according to an embodiment of the present invention.

FIG. 2 shows an exemplary schematic diagram of a sniffer device according to an embodiment of the present invention.

FIG. 3 shows an exemplary state machine for wireless connection according to an embodiment of the present invention.

FIG. 4 shows an exemplary flowchart of a method for disrupting undesirable wireless communication according to an embodiment of the present invention.

FIG. 5 shows an exemplary deadlock of state machines according to an embodiment of the present invention.

### DETAILED DESCRIPTION OF THE INVENTION

According to the present invention, techniques for wireless computer networking are provided. More particularly, the present invention provides methods and systems for improving security of wireless networks. In a specific embodiment, methods and systems are provided for enhancing security of wireless networking environments characterized by the IEEE 802.11w and related protocols, and their variants.

Using recent (and increasingly popular) wireless technologies, wireless access to the LANs in the offices, homes, public hot-spots, and other geographical locations can be provided. The IEEE 802.11 family of standards (also called Wireless Local Area Network, WLAN or WiFi) are popular for such wireless communication. In WiFi, the 802.11b standard provides for wireless connectivity at speeds up to 11 Mbps in the 2.4 GHz radio frequency spectrum; the 802.11g standard provides for even faster connectivity up to about 54 Mbps in the 2.4 GHz radio frequency spectrum; and the 802.11a standard provides for wireless connectivity at speeds up to about 54 Mbps in the 5 GHz radio frequency spectrum. Wireless communication standards that offer even higher data rates such AS 802.11n and/or operate in different frequency spectrums such as 802.16 are also possible.

Advantageously, WiFi can facilitate a quick and effective way of providing wireless extension to existing LAN. To provide this wireless extension, one or more WiFi access points (APs) can connect to the connection ports either directly or through intermediate equipment, such as WiFi switch. After an AP is connected to a connection port, a user can access the LAN using a device (called a “station” or a “client”) equipped with WiFi radio. Examples of the devices equipped with WiFi radio include but not limited to laptop computers, personal digital assistants (PDAs), handheld scanners, fixed computers etc. The station can wirelessly communicate with the AP and the AP can transfer information between wired and wireless portions of the LAN.

WiFi uses radio signals for information transfer. Since wireless signals cannot be confined to physical boundaries of premises, they often cause a concern to the owner of the wireless computer network. In particular the owners are concerned about spillage of wireless signals from the computer network into outside of the premises (e.g., home, office, building, campus etc.) as the spillage of signals can be used for unauthorized access to the wireless computer network. For example, unauthorized wireless clients (e.g., neighbor's clients or other clients in parking lot, street etc.) can access the computer network using this spillage. Also authorized clients can accidentally or deliberately attempt connection to external (e.g., neighbor's) computer networks using radio spillage of those networks. It is also common to find wireless APs connected to the LAN by employees without the knowledge of administrator. Whether such action is inadvertent or malicious, such APs may not employ the correct security controls and hence their signal spillage may provide easy avenue for hackers outside the LAN premises to gain unauthorized access to the LAN. Therefore a need arises to improve security of wireless computer networks.

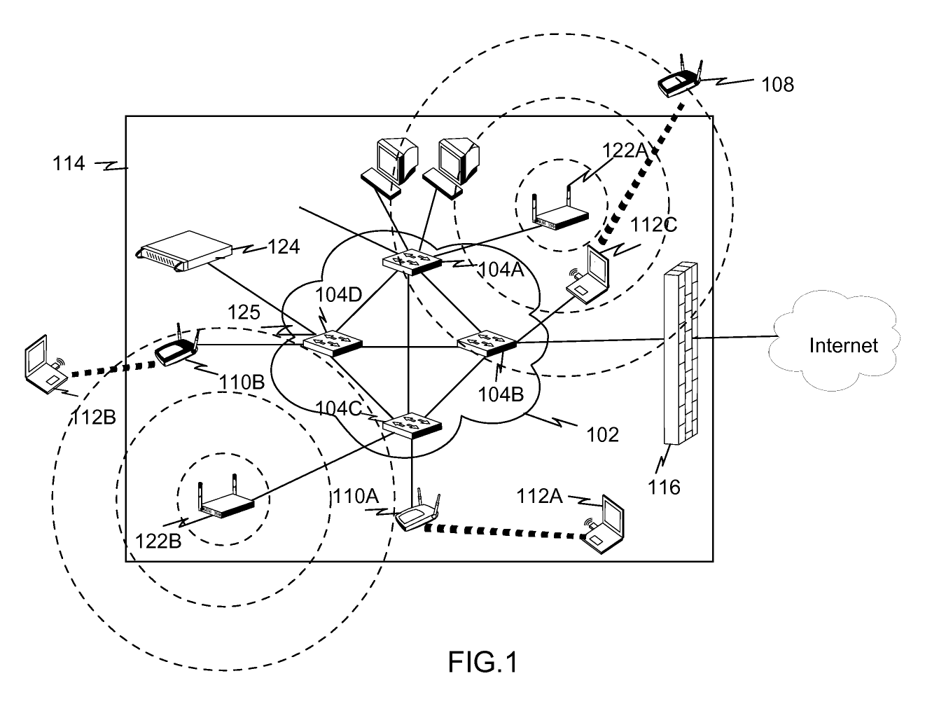

FIG. 1 illustrates an exemplary local area network (LAN) of computing systems that can facilitate an environment for embodiments of the present invention to be practiced. This diagram is merely an example which should not unduly limit the scope of the claims herein.

As shown, a core transmission infrastructure 102 of the LAN can include various transmission components, e.g., hubs, switches, and routers (104A-104D), interconnected using wires. The LAN core 102 can be connected to the Internet through the firewall (116). In a typical deployment, the LAN core 102 comprises one or more network segments. In an embodiment, a network segment can be an IP “subnetwork” (called “subnet”). Each subnet can be identified by a network number (e.g., IP number and subnet mask) and a plurality of subnets are interconnected using router devices. In an embodiment, a network segment can be a VLAN (Virtual LAN). Notably, one or more of the network segments can be geographically distributed (e.g., in offices of a company in different geographic locations). The geographically distributed segments can be interconnected via virtual private network (VPN).

In this embodiment, a wireless extension of the LAN core 102 is also provided. For example, one or more authorized APs 110A can be connected to the LAN core 102. In this configuration, authorized computing devices 112A (such as desktop computers, laptop computers, handheld computers, PDAs, etc.) equipped with radio communication can wirelessly connect to LAN through the authorized AP 110A. Notably, authorized APs connected to the LAN provide wireless connection points on the LAN. Note that the Institute of Electrical and Electronics Engineers (IEEE) 802.11 family of standards such as 802.11a,b,g,n,i,w etc.(referred as WLAN or WiFi) or another type of wireless network format (e.g., UWB, WiMax, Bluetooth, etc.) can be used to provide the wireless protocols.

According to certain procedure in the IEEE 802.11 MAC protocol an AP periodically transmits beacon packets (hereafter called “beacons”) to announce its existence. Clients will receive these beacons and connect to the AP. Connection establishment between the client and the AP is facilitated by “authentication” and “association” procedures as described in the IEEE 802.11 MAC protocol, and in some embodiments augmented by the security enhancements such as 802.1x, WPA, IEEE 802.11i, IEEE 802.11w etc. Once a client is connected to the AP, it can utilize the services of the AP to access the LAN, and transmit and/or receive “data” packets. Further, breaking of connection between the AP and the client is facilitated by procedures such as “deauthentication” and “disassociation”.

FIG. 1 also shows that an unauthorized AP 110B can be connected into the LAN (e.g., using connection port or access port on the switch) by unassuming or malicious user of the LAN. The radio coverage of an unauthorized AP 110B can spill outside the region of operation 114 of the LAN (e.g., building, office, campus, and/or premises within which the LAN operates). Using this radio spillage unauthorized devices 112B (e.g., user on street, parking lot, neighboring premises) can access the LAN through the unauthorized AP. Notably, unlike the authorized AP 110A, the unauthorized AP 110B may not be managed by the administrator of the LAN and hence may not employ the appropriate security measures (e.g., authentication, encryption etc.) while allowing the users to access the LAN through itself. The unauthorized AP 110B can operate as a layer 2 bridging device or as a router/NAT (network address translator) device. In alternative embodiment, the authorized AP 110A can be misconfigured and can create security vulnerability. Unauthorized users (such as wireless devices 112B) can also gain unauthorized wireless access to the LAN via the misconfigured AP (e.g., if the configuration on the authorized AP 110A were to be improperly set thereby opening a security hole).

In yet an alternative embodiment, the radio coverage of an AP 108 operating outside the premises 114 of the LAN, can spill inside the LAN premises. For example, the AP 108 can be an AP operating in the neighboring premises, an AP in a parking lot or a street, a hacker's AP and like. This radio spillage may lead to authorized wireless devices 112C in the LAN connecting unwittingly or deliberately to such an AP, thereby creating security vulnerability for the device 112C and/or the LAN 102.

In accordance with an aspect of the present invention, a security monitoring system can detect undesirable wireless communication of devices associated with the LAN. Moreover, the system can disrupt the undesirable wireless communication thus preventing security breaches over it. The security monitoring system can include one or more RF sensor devices (e.g., sensor devices 122A and 122B, each generically referenced herein as a sniffer 122) disposed within and/or in a vicinity of the region of operation of the LAN. In an embodiment (shown in FIG. 1), sniffer 122 can be connected to the LAN core 102 using wired connection. In another embodiment, sniffer 122 can be connected to the LAN core 102 using a wireless connection.

In an embodiment, a sniffer 122 is able to monitor wireless activity in a subset of the region of operation of the LAN. Wireless activity can include any transmission of control, management, or data packets between an AP and one or more wireless stations, or among one or more wireless stations.

In general, sniffer 122 can listen to a radio channel and capture transmissions on that channel. In an embodiment, sniffer 122 can cycle through multiple radio channels on which wireless communication could take place. On each radio channel, sniffer 122 can wait and listen for any ongoing transmission. In an alternative embodiment, sniffer 122 can operate on multiple radio channels simultaneously.

Whenever a transmission is detected, sniffer 122 can collect and record the relevant information about that transmission. This information can include all or a subset of information gathered from various fields in a captured packet. In another embodiment, a receive signal strength indicator (RSSI) associated with the captured packet can also be recorded. Other information such as the day and the time the transmission was detected can also be recorded. The information collected by one or more sniffers can be used to detect undesirable wireless communication.

A sniffer 122 can transmit packets over the wireless medium. These packet transmissions can facilitate disrupting of the detected undesirable wireless communication according to an aspect of the present invention.

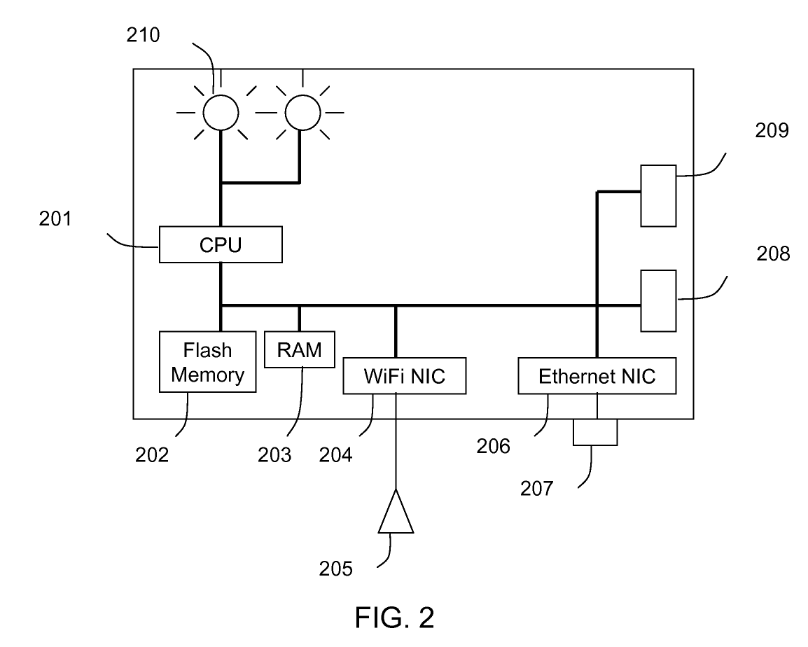

An exemplary hardware diagram of the sniffer is shown in FIG. 2. This diagram is merely an example, which should not unduly limit the scope of the claims herein. One of ordinary skill in the art would recognize many variations, alternatives, and modifications. As shown, sniffer 122 can have a central processing unit (CPU) 201, a flash memory 202 where the software code for sniffer functionality resides, and a RAM 203 which can serve as volatile memory during program execution. The sniffer 122 can have one or more 802.11 wireless network interface cards (NICs) 204 which perform radio and wireless MAC layer functionality and one or more of dual-band (i.e., for transmission detection in both the 2.4 GHz and 5 GHz radio frequency spectrums) antennas 205 coupled to the wireless NICs. Each of the wireless NICs 204 can operate in 802.11a, 802.11b, 802.11g, 802.11b/g or 802.11a/b/g mode. In an embodiment, alternatively or in addition to, at least one of the NICs can operate in 802.11n mode. Moreover, the sniffer 122 can have an Ethernet NIC 206 which performs Ethernet physical and MAC layer functions, an Ethernet jack 207 such as RJ-45 socket coupled to the Ethernet NIC for connecting the sniffer device to wired LAN with optional power over Ethernet or POE, and a serial port 208 which can be used to flash/configure/troubleshoot the sniffer device. A power input 209 is also provided. One or more light emitting diodes (LEDs) 210 can be provided on the sniffer device to convey visual indications (such as device working properly, error condition, undesirable wireless activity alert, and so on).

In an embodiment, sniffer 122 can be built using a hardware platform similar to that used to build an AP, although having different functionality and software. In an embodiment, both the sniffer and the AP functionality can be provided in the same hardware platform. In another embodiment, the sniffer functionality is provided as software that is run on one or more computers in the wireless network.

Server 124 (also called “security appliance”) can be coupled to LAN 102 using a connection port 125. In an embodiment, each sniffer 122 can convey its information about detected wireless activity to server 124 (i.e., over the LAN). Servers 124 can then analyze that information, store the results of that analysis, and process the results. In an embodiment, sniffer 122 may filter and/or summarize its information before conveying it to server 124. Sniffer 122 may also receive specific instructions from server 124, e.g. tuning to specific radio channel, detecting transmission of specific packets on a radio channel, indication about undesirable wireless activity etc. In an alternative embodiment, the sniffer 122 can operate as a standalone device without having to communicate with the server.

Preferably, the security system comprising sniffers 122 and optionally server 124 can detect unauthorized APs connected into the LAN core. Several techniques for detecting such unauthorized APs are described in the U.S. Application Publication 20050195753 to Chaskar et al. entitled “Method and system for detecting wireless access devices operably coupled to computer local area networks and related methods” published Sep. 8, 2005; the U.S. Application Publication 20060193300 to Rawat et al. entitled “Method and apparatus for monitoring multiple network segments in local area networks for compliance with wireless security policy” published Aug. 31, 2006; and the U.S. Pat. No. 7,154,874 to Bhagwat et al. entitled “Method and system for monitoring a selected region of an airspace associated with local area networks of computing devices” Dec. 26, 2006; each of which is herein incorporated by reference.

Preferably, when the unauthorized AP (e.g., 110B) is detected, a misconfigured AP is detected (e.g., an authorized AP 110A whose configuration is not properly set), a misassociation is detected (e.g., wireless connection between the authorized client 112C and external AP 108), an unauthorized association is detected (e.g., external client 112B connecting via authorized AP 110A to the LAN) and like, the security monitoring system can disrupt such wireless communication to prevent security breach over it. A popular method for a sniffer in the security monitoring system to disrupt such wireless communication is to disconnect undesirable wireless link between the AP and the client station by constructively using deauthentication and disassociation procedures provided in the IEEE 802.11 MAC standard. The procedures, the frame formats and other information about the IEEE 802.11 MAC standard can be found in the publication of IEEE titled “Part 11: Wireless LAN Medium Access Control (MAC) and Physical Layer (PHY) Specifications”, 1999 Edition, which is herein incorporated by reference. For example, the deauthentication procedure or the disassociation procedure can be constructively utilized by the sniffer 122 to break the wireless link (connection) between unauthorized AP 110B and a client 112B, wireless link between authorized client 112C in the LAN and neighbor's AP 108 etc.

As merely an example, in order to disrupt wireless communication between the AP 110B and the client 112B, the sniffer 122B can use deauthentication procedure. In a typical deauthentication process, the sniffer can transmit spoofed deauthentication packets (frames) on the same channel on which the wireless link between the AP and the client operates. For example, the sniffer can generate one or more IEEE 802.11 frames with type field set as “management” and subtype field set as “deauthentication”. Moreover the source address field is set to the wireless MAC address of the AP 110B (that is, the sniffer spoofs the wireless MAC address of the AP 110B), the destination address field is set to the wireless MAC address of the client 112B (or, to a broadcast adddress of hexadecimal FF:FF:FF:FF:FF:FF), and the BSSID field set to a value same as that used by the frames transmitted by the AP 110B to the client 112B or vice versa (which usually is the wireless MAC address of the AP). When the client 112B receives this frame, it thinks that the AP 110B (e.g., based on the source MAC address field) wants it to disconnect and the client disconnects from the AP. Alternatively, the source address field can be set to the wireless MAC address of the client 112B (that is, the sniffer spoofs the wireless MAC address of the client) and the destination address field can be set to the wireless MAC address of the AP 110B. This results in the AP thinking that the client wants to disconnect and the AP disconnects the client.

Just as deauthentication and disassociation procedures can be constructively used by the sniffer in the security monitoring system to prevent undesirable communication, they are also infamous denial of service (DOS) attack procedures and can be used for destructive purposes. See for example, Bellardo and Savage, “802.11 Denial of Service Attacks: Real Vulnerabilities and Practical Solutions”, 12^{th} USENIX Security Symposium, August 2003; and A. Vladimirov, K. Gavrilenko, and A. Mikhailovsky, “Wi-Foo The Secrets of Wireless Hacking”, Addison-Wesley, 2004, pp. 123-133). For example, a miscreant such as hacker sitting in parking lot or in neighboring premises can use these procedures against legitimate wireless communication in the LAN and cause disruption to the LAN. The IEEE standardization body has recently provided a protocol called IEEE 802.11w to make IEEE 802.11 MAC protocol resistant to DOS attacks launched using deauthentication and disassociation procedures. Specifically, the IEEE 802.11w protocol specifies that a client will disregard a disconnection request such as deauthentication or disassociation from the AP (i.e., the disconnection request including the AP's MAC address as source address) unless it can validate that it is indeed sent from the AP to which the client station is associated with (connected with). Similarly, the AP will disregard a disconnection request from the client (i.e., the disconnection request including the client's MAC address as source address) unless it can validate that it is indeed sent from the purported client. In this embodiment, disregarding the disconnection request means not disconnecting the wireless link, that is, maintaining the wireless link in a state of being associated in accordance with an IEEE 802.11 MAC protocol even after deauthentication or disassociation frame is received from the peer. In this embodiment, honoring the disconnection request means disconnecting the wireless link, that is, driving the wireless link in a state of being unassociated in accordance with an IEEE 802.11 MAC protocol upon receiving deauthentication or disassociation frame from the peer.

For the validation of the disconnection request (e.g., deauthentication, disassociation etc.), the 802.11w protocol recommends that the disconnection request be authenticated using a shared secret key (e.g., a digital key) that is shared between the AP and the client. That is, the sender of the disconnection request creates a digital signature on the disconnection request using the shared secret key and the recipient validates this digital signature using the shared secret key before honoring the request. If the validation fails, it can be an indication that the disconnection request is spoofed (that is, transmitted by some device other than the device associated with the purported source identity in the request) and hence the request is disregarded. If the validation passes, it can be an indication that the disconnection request is non-spoofed (that is, actually transmitted by the device associated with the purported source identity in the request) and hence the request is honored. The 802.11w protocol can resist DOS attacks launched using deauthentication and disassociation procedures. Since the DOS attacker is not expected to have knowledge of the shared secret between the AP and the client, the DOS attacker cannot create the proper digital signature on the disconnection request. The attacker's disconnection requests will thus be disregarded by the AP and/or the client.

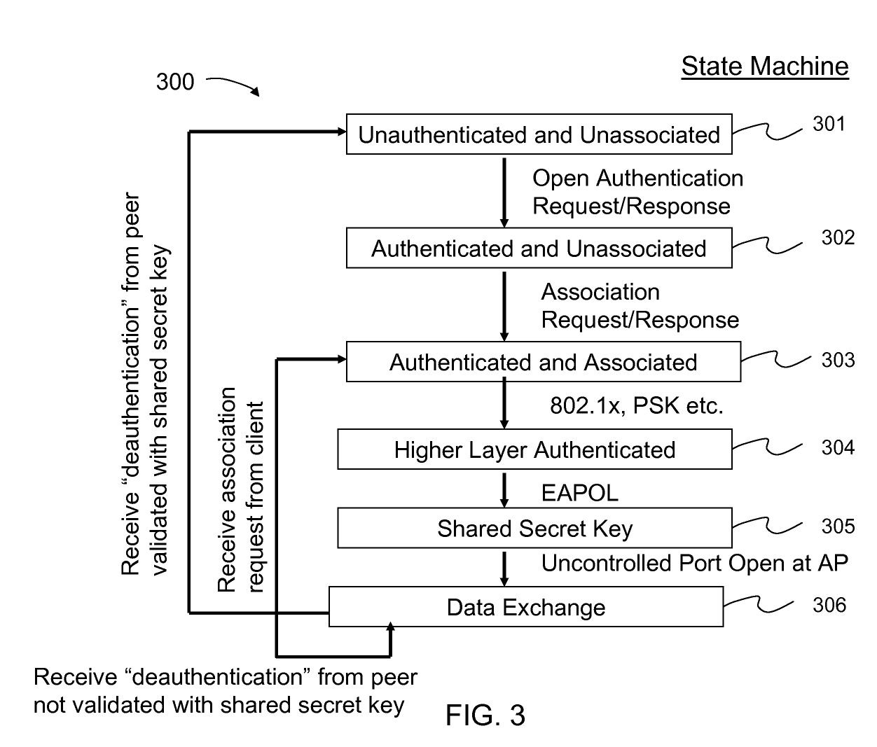

FIG. 3 shows an exemplary connection state machine 300 for a wireless connection between the AP and the client operating according to an IEEE 802.11w protocol. This diagram is merely an example, which should not unduly limit the scope of the claims herein. As shown, connection state machine 300 at each of the AP and the client passes through states 301, 302, 303, 304, 305, and 306. That is, the state machines at the AP and the client pass through these states in a substantially synchronized manner in a preferred embodiment. In state 301 (Unauthenticated and Unassociated), in an embodiment the client discovers APs in its vicinity, for example, using channel scanning and probing. The client and the AP then perform legacy authentication procedure, also called layer 2 authentication, using authentication request (e.g., from the client) and response (e.g., from the AP) message transaction. In this embodiment, the layer 2 authentication can be an open authentication, that is, no authentication at all. Upon completion of the open authentication, the state machine at each of the client and the AP enters state 302 (Authenticated and Unassociated). In this state 302, the client and the AP perform association procedure using association request (e.g., from the client) and response (e.g., from the AP) message transaction. At the completion of the association procedure, the state machine at each of the client and the AP enters state 303 (Authenticated and Associated). Additional details on the states 301, 302, and 303 can be found in the IEEE 802.11 MAC standard and throughout the present specification. In the state 303, the client and the AP can perform higher layer authentication using protocols such as 802.1x protocol, PSK (pre-shared key) protocol and like. In this embodiment, the higher layer authentication can be performed using passwords, certificates, smart cards and like. Upon completion of the higher layer authentication, the state machine enters state 304 (Higher Layer Authenticated). More details on the state 304 can be found in the IEEE 802.11i protocol description and throughout the present specification. For example, the IEEE 802.11i protocol description can be found in the publication of the IEEE titled “Part 11: Wireless LAN Medium Access Control (MAC) and Physical Layer (PHY) Specifications: Medium Access Control (MAC) Security Enhancements”, October 2003 Edition, which is herein incorporated by reference.

Additionally, from state 304 each of the AP and the client acquire shared secret keys to be used in encryption of data, authentication of the disconnection messages (e.g., deauthentication and disassociation) from the peer. As merely an example EAPOL protocol can be used for acquiring the shared secret keys. When EAPOL protocol transaction is completed, the state machine at each of the AP and the client enters state 305 (Shared Secret Key). For example, a shared secret key called DGTK (Disconnect Group Transfer Key) is used for validating (i.e., authenticating) the disconnection requests from the AP to broadcast destination address. In this embodiment, the disconnection requests to the broadcast destination address can be used to instruct all clients to disconnect from the AP. As another example a shared secret key called PTK (Pairwise Transient Key) is used for validating the disconnection requests from the AP to the destination address of the specific client and vice versa. Additional details on state 305 can be found in the IEEE 802.11i protocol description, the IEEE 802.11w protocol description, and throughout the present specification. For example, the IEEE 802.11w protocol description can be found in the publication of IEEE titled “Part 11: Wireless LAN Medium Access Control (MAC) and Physical Layer (PHY) Specifications Amendment-w: Protected Management Frames”, March 2005 Edition, which is herein incorporated by reference. After acquiring the shared secret keys in state 305, the AP opens data port (called as uncontrolled port) and the state machine enters state 306 (Data Exchange). In the Data Exchange state, the AP can receive data packets from the client and vice versa. As further shown in FIG. 3, if an association request message is received in state 306 from the client, the state machine at the AP can go to the state 303. Further, in state 306, if the deauthentication message is received from the peer, in an embodiment, the state machine goes to state 301 only if the deauthenitcation message is validated with the shared secret key (e.g., DGTK, PTK etc.).

As a side effect of operation according to the IEEE 802.11w protocol and its variants, it may become impractical for a sniffer to disrupt undesirable wireless connection between the AP and the client using conventional deauthentication and/or disassociation without the knowledge of the shared secret key which is often the case. Improved techniques to disrupt undesirable wireless connection between the AP and the client from the sniffer are thus required to address the threat of undesirable wireless links using the 802.11w protocol and its variants. The present invention provides such improved techniques. As merely an example, a variant of the 802.11w protocol is called MFP (Management Frame Protection) protocol. Other variants are possible too and should not limit the scope of the claims herein.

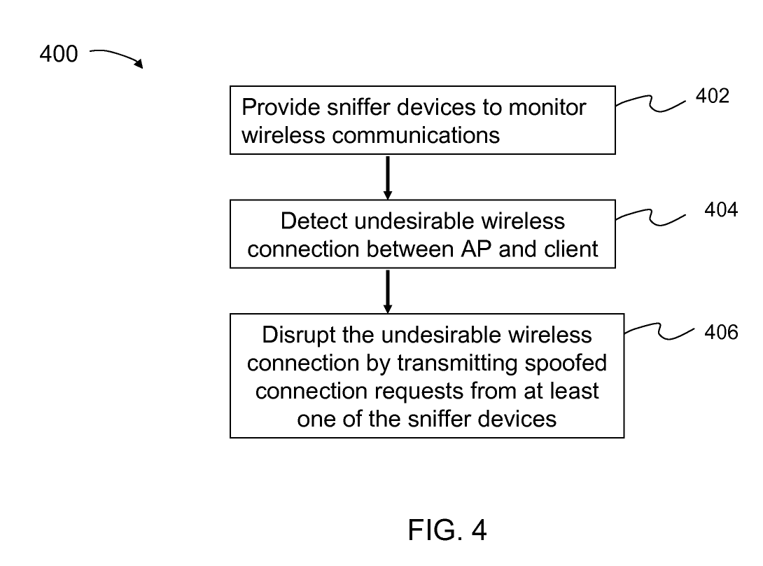

FIG. 4 illustrates an exemplary flowchart for method 400 for disrupting undesirable wireless communication according to an embodiment of the present invention. This diagram is merely an example which should not unduly limit the scope of the claims herein. As shown, step 402 can provide one or more sniffer devices (e.g., sniffers 122) to monitor wireless communications in a wireless network (e.g., LAN with wireless extensions as shown in FIG. 1). Preferably the sniffer devices are spatially disposed over the geographic region of the wireless network.

At step 404, the method can detect a wireless connection established between an access point device and a client device. For this, in a specific embodiment, the sniffer can capture one or more packets (e.g., 802.11 frames) transmitted on a wireless medium. The selected MAC addresses in the captured packet (e.g., one or more of source address, destination address, transmitter address, receiver address, BSSID address etc.) can be identified as the wireless MAC addresses of the access point device and the client device, respectively. In some embodiments the TO DS and FROM DS bits in the 802.11 MAC header of the captured packet can also be used in identifying the AP and the client MAC addresses. As merely an example, if the TO DS bit in the 802.11 MAC header of the packet is detected to be a binary 1 and the FROM DS bit is detected to be a binary 0, it can be inferred that the packet was transmitted from the client to the AP, and further that the BSSID field indicates the wireless MAC address of the AP and the source address field indicates the wireless MAC address of the client. Moreover, from certain fields in the captured packet, it can be inferred that the state of the wireless connection at the AP and the client each being a Data Exchange state, that is the wireless connection is fully established. As merely an example, it can be inferred from the Type field in the 802.11 MAC header being indicative of data (e.g., value of 10 for the Type field bits b3 and b2) that the packet is a data packet and it can be inferred from the Type field in the LLC (Logical Link Control) header that the packet is exchanged in Data Exchange state unlike Authenticated and Associated state in which also packets of type data are exchanged for the purpose of higher layer authenticating (e.g., Type field in the LLC header indicating that the data packet is not an 802.1x packet). In an alternative embodiment, the sniffer can detect the wireless connection based on information received from other systems in the network. As merely an example, the other systems in the network that can provide this information include access point controller, network management system etc.

In the preferred embodiment according to the present invention, the wireless connection established between the AP and the client is configured for not being disconnected upon receiving a spoofed disconnection request transmitted from a wireless device (e.g., a sniffer device 122, a DOS attacker device etc.) other than the access point device and the client device. In an embodiment, the spoofed disconnection request can includes the access point's (AP's) identity as the identity of the originator of the request (e.g., AP's wireless MAC address as source address in deauthentication transmitted to the client's wireless MAC address as destination address), even though the disconnection request is in fact transmitted by a device other than the AP (e.g., a sniffer device 122, a DOS attacker device etc.). Alternatively, the spoofed disconnection request can includes the client's identity as the identity of the originator of the request (e.g., client's wireless MAC address as source address in deauthentication transmitted to the AP's wireless MAC address as destination address), even though the disconnection request is in fact transmitted by a device other than the client (e.g., a sniffer device 122, a DOS attacker device etc.). The access point device or the client device is able to detect that such disconnection request received with the peer's identity (e.g., wireless MAC address) included in the request as the originator of the request (e.g., source address field of deauthentication) is a spoofed one (e.g., in fact originated or transmitted by device other than the peer) and disregard the request. Such a wireless connection can be resistant to DOS attacks. For example, the wireless connection can be provided using an IEEE 802.11w protocol described throughout the present specification. The validity of the disconnection request can then be checked using shared secret keys.

In this embodiment, the wireless connection so detected is undesirable. As merely an example, as shown in FIG. 1, it can be a wireless connection unauthorized AP 110B and a client 112B, between authorized client 112C in the wireless network and neighbor's AP 108, and so on. Preferably the wireless connection needs to be disrupted by the security monitoring system to prevent security breach over it.

At step 406 the method can disrupt the wireless connection established between the access point device and the client device by transmitting one or more spoofed connection requests from at least one of the sniffer devices. In an embodiment, the spoofed connection requests can comprise association request frames formatted in accordance with an IEEE 802.11 MAC protocol. More specifically, a source address in the association request frame transmitted (e.g., originated) by the sniffer device is set to a wireless MAC address of the client device (e.g., the sniffer device spoofs the client's wireless MAC address) and a destination address in the association request frame is set to a wireless MAC address of the access point device. Notably conventionally association request frame is used to start a new connection (e.g., as shown in the state diagram 300 in FIG. 3), however according to the present invention it is used to disrupt the established wireless connection as described in more detail below and throughout the present specification. In this embodiment, disrupting the established wireless connection includes obstructing the transfer of data packets between the AP and the client over the wireless connection as described throughout the present specification and more particularly below.

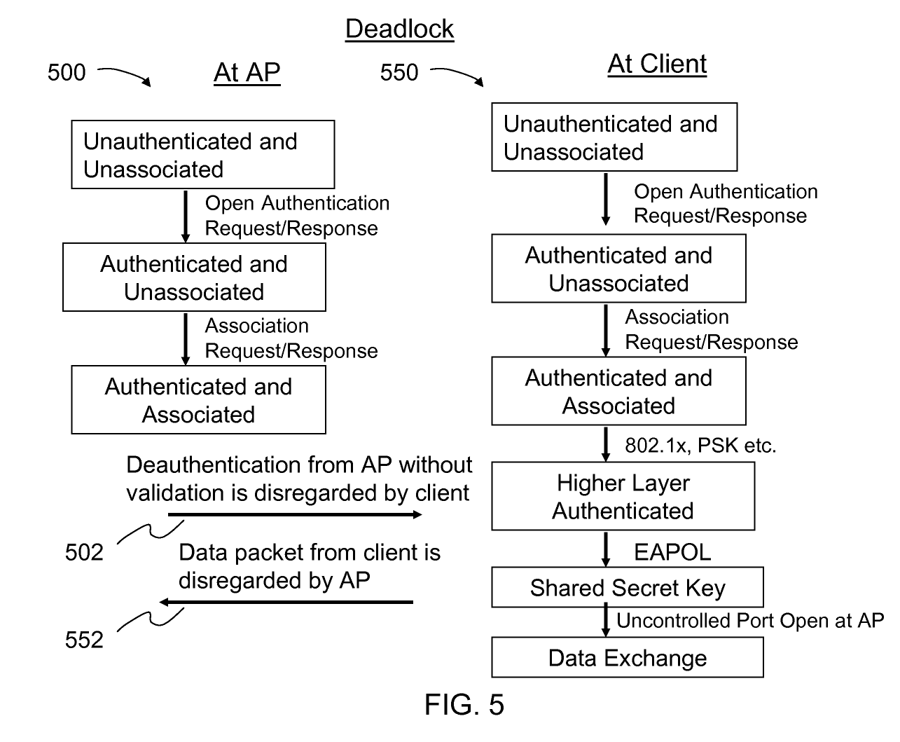

In accordance with an embodiment of the present invention, the state machine in the AP upon receiving the association request goes to state 303 shown in FIG. 3, that is, to a state of being Authenticated and Associated, but not Higher Level Authenticated. In this state, the AP does not accept any frames from client of type data (that is, other than authentication frames) as those frames are not allowed unless the state machine passes the state 305 shown in FIG. 3. Moreover, in the state 303, the AP does not maintain the shared secret keys (e.g., DGTK, PTK etc.) as those are not allowed to be created before state machine passes the state 304. On the contrary, the state machine at the client still remains in the state of 306 (Data Exchange). In the Data Exchange state, the client maintains the shared secret keys and expects the AP to validate any disconnection requests with one or more of these keys. The states of the wireless connection at the AP and the client are thus out of synchronization. Alternatively, the state machines at the AP and the client are deadlocked as illustrated in FIG. 5. FIG. 5 is merely an example which should not unduly limit the scope of the claims herein.

As shown in FIG. 5, the state machine 500 at the AP goes to a state of being Authenticated and Associated (e.g., state 303 as illustrated in FIG. 3) upon receiving spoofed connection request from the sniffer. The state machine 550 at the client remains in a state of Data Exchange (e.g., state 306 as illustrated in FIG. 3). The AP expects the client to initiate higher level authentication for state machine 500 to evolve beyond the state of Authenticated and Associated. However, the client state machine 550 having already passed the state of being Higher Level Authenticated, the client does not initiate the higher level authentication.

The client can however continue to send data packets (552) to the AP, as the state machine at the client is in the Data Exchange state. The AP disregards these data packets as the AP is not allowed to receive data packets when the state machine at the AP is in state 303. In this embodiment, disregarding the data packet can include dropping the data packet, not forwarding the data packet, not processing at least a portion of the data packet and like. In an embodiment, realizing that the state machine at the client being off-track, the AP can send deauthentication (502) to the client or to a broadcast destination address in an attempt to disconnect the wireless link and re-synchronize the state machines at the AP and the client. However, the client disregards this deauthentication, as in the state 306, the client is not allowed to honor the deauthentication unless it can be validated with the shared secret key. In this embodiment, disregarding the deauthentication can include maintaining the state machine at the client device in the state 306 as shown in FIG. 3. Note the AP does not possess the shared secret key to validate (e.g., authenticate) the deauthentication since the AP's state machine is still at state 303.

The wireless communication over the wireless link between the AP and the client is thus disrupted. For example, the AP and the client are obstructed from transferring data packets to each other as described. In an embodiment, this situation continues until, for example, the client detects that no response is received to its data packets, infers that the link is broken, and sends fresh association request which can then resynchronize the state machines at the AP and the client. After the link is re-established, another spoofed connection request from the sniffer can again put it in a deadlocked condition. In an embodiment, by sending a continuous stream of spoofed connection requests from the sniffer, the link can be kept deadlocked for most of the time and thus wireless communication between the AP and the client is disrupted.

It should be appreciated that the specific steps illustrated in FIG. 4 provide a particular method of disrupting undesirable wireless communication according to an embodiment of the present invention. Other sequences of steps may also be performed according to alternative embodiments. For example, alternative embodiments of the present invention may perform the steps outlined above in a different order. Moreover, the individual steps illustrated in FIG. 4 may include multiple sub-steps that may be performed in various sequences as appropriate to the individual step. Furthermore, additional steps may be added or removed depending on the particular applications. One of ordinary skill in the art would recognize many variations, modifications, and alternatives based on the teachings of this present specification.

In an alternative embodiment, the present invention provides a system for disrupting undesirable wireless communication. The system can be implemented as a computing system comprising computer readable instructions (e.g., computer codes) stored in electronic memory module (e.g., RAM, ROM, hard drive, networked drives, USB, flash etc.). The computer readable instructions can be executed by a processor module to perform the steps as in method 400. The processor module can comprise one or more micro processing devices (e.g., microprocessor, microcontroller, digital signal processor etc.). The computing system according to an embodiment of the present invention also comprises a transmitter module. The transmitter module comprises one or more network interfaces (e.g., WiFi radio interfaces) which can transmit wireless signals. In an embodiment, the memory module, the processor module and the transmitter module are all provided within a sniffer apparatus (e.g., as shown in FIG. 2). In an alternative embodiment a first portion of at least one of the memory module, the processor module, or the transmitter module is provided in a server device (e.g., server 124 shown in FIG. 1), and a second portion is provided in a sniffer apparatus. The server device can communicate with the sniffer apparatus over a computer network (e.g., LAN, VPN etc.). Other alternatives are also possible and will be apparent from the teachings of the present specification to those with ordinary skill in the art.

Although specific embodiments of the present invention have been described, it will be understood by those of skill in the art that there are other embodiments that are equivalent to the described embodiments. As merely an example, while the specific embodiments have been described for infrastructure mode wireless connection (e.g., wireless connection between AP and client), the techniques of the present invention can also be used for ad hoc wireless connection (e.g., wireless connection between two client devices) that operates in accordance with the IEEE 802.11w type protocols and their variants. As another example, certain alternative embodiment can include sending one or more spoofed connection responses (e.g., association response frames containing wireless MAC address of the AP in source address field and wireless MAC address of the client in destination address field, layer 2 authentication response frames etc.) from the sniffer device to disrupt the undesirable wireless link by inducing deadlock between state machines at the AP and the client. As another example, in certain alternative embodiments one or more spoofed connection requests transmitted by the sniffer can include authentication request, EAPOL START request, or combination of two or more of association request, authentication request (e.g., layer 2 authentication request), EAPOL START request etc. As yet another example, teachings of the present invention can be used for wireless connections operating according to different versions/revisions of the IEEE 802.11w protocol, their proprietary implementations, modifications, or other protocols which operate in a manner substantially similar to the IEEE 802.11w protocol. Other alternative embodiments are also possible. Accordingly, it is to be understood that the invention is not to be limited by the specific illustrated embodiments, but only by the scope of the appended claims.

1. A method for disrupting undesirable wireless communication in wireless network, the method comprising:
providing one or more sniffer devices to monitor wireless communications in a wireless network;
detecting a wireless connection established between an access point device and a client device using the one or more sniffer devices, the wireless connection being configured for not being disconnected upon receiving a spoofed disconnection request transmitted from a wireless device other than the access point device and the client device; and
disrupting the wireless connection established between the access point device and the client device by transmitting one or more spoofed connection requests from at least one of the one or more sniffer devices.

2. The method of claim 1 wherein the spoofed disconnection request transmitted by the wireless device other than the access point device and the client device comprises a deauthentication frame, the deauthentication frame being formatted in accordance with an IEEE 802.11 MAC protocol.

3. The method of claim 2 wherein a source address in the deauthentication frame being a wireless MAC address of the access point device and a destination address in the deauthentication frame being a wireless MAC address of the client device or a broadcast wireless MAC address.

4. The method of claim 3 wherein the wireless device other than the access point device and the client device spoofs the wireless MAC address of the access point device.

5. The method of claim 2 wherein a source address in the deauthentication frame being a wireless MAC address of the client device and a destination address in the deauthentication frame being a wireless MAC address of the access point device.

6. The method of claim 1 wherein the wireless connection being configured for being disconnected upon receiving a non-spoofed disconnection request at least one of the access point device or the client device.

7. The method of claim 6 wherein the non-spoofed disconnection request received at the at least one of the access point device or the client device is validated using a secret key, the secret key being negotiated between the access point device and the client device.

8. The method of claim 7 wherein the wireless device other than the access point device and the client device is without knowledge of the secret key negotiated between the access point device and the client device.

9. The method of claim 1 wherein the wireless connection established between the access point device and the client device being provided in accordance with an IEEE 802.11w type protocol.

10. The method of claim 1 wherein at least one of the one or more spoofed connection requests transmitted from the at least one of the one or more sniffer devices comprises an association request frame, the association request frame being formatted in accordance with an IEEE 802.11 MAC protocol.

11. The method of claim 10 wherein a source address in the association request frame being a wireless MAC address of the client device and a destination address in the association request frame being a wireless MAC address of the access point device.

12. The method of claim 1 wherein the disrupting the wireless connection comprises driving states associated with the wireless connection at the access point device and the client device, respectively, out of synchronization with each other.

13. The method of claim 1 wherein a state of the wireless connection at the access point device and a state of the wireless connection at the client device being states of data exchange, respectively, prior to the disrupting of the wireless connection.

14. The method of claim 13 wherein the states of the wireless connection at the access point device and the client device are each with knowledge of a shared secret key, the shared secret key being used to validate one or more disconnection requests received by at least one of the access point device or the client device.

15. The method of claim 14 wherein the disrupting the wireless connection comprises driving the state of the wireless connection at the access point device to a state of authenticated and associated, and maintaining the state of the wireless connection at the client device at the state of data exchange.

16. The method of claim 15 wherein the state of authenticated and associated is without knowledge of the shared secret key.

17. The method of claim 16 wherein a disconnection request transmitted from the access point device in the state of authenticated and associated is without being validated with the shared secret key.

18. The method of claim 17 wherein the disconnection request from the access point device that is without being validated with the shared secret key is disregarded by the client device.

19. The method of claim 18 wherein a data frame transmitted by the client device is disregarded by the access point device.

20. The method of claim 19 wherein the access point device and the client device are deadlocked.

21. A method for disrupting undesirable wireless communication in wireless network, the method comprising:
providing one or more sniffer devices spatially disposed over a geographic region associated with the wireless network to monitor wireless communications in the wireless network;
receiving information associated with an undesirable wireless link between an access point device and a client device at at least one of the one or more sniffer devices, the information including wireless MAC addresses of the access point device and the client device, respectively; and
driving the undesirable wireless link between the access point device and the client device in a state of deadlock by transmitting one or more spoofed connection requests from at least one of the one or more sniffer devices while the undesirable wireless link is in a state of being connected, each of the one or more spoofed connection requests including the wireless MAC address of the client device as originator identity and the wireless MAC address of the access point device as destination identity.

22. The method of claim 21 wherein the state of being connected is a state of data exchange at each of the access point device and the client device.

23. The method of claim 21 wherein the state of deadlock is characterized by a state of the wireless link at the access point device being a state of authenticated and associated and a state of the wireless link at the client device being a state of data exchange.

24. The method of claim 23 wherein the state of the wireless link at the access point device being waiting on the client device to initiate a higher layer authentication.

25. The method of claim 23 wherein the state of the wireless link at the client device being passed the higher layer authentication.

26. An apparatus for disrupting undesirable wireless communication, the apparatus comprising:
a memory module comprising one or more computer memory devices, the memory module storing:
one or more first codes for receiving information associated with a wireless connection established between an access point device and a client device in a wireless network, the information including wireless MAC addresses of the access point device and the client device, respectively;
one or more second codes for receiving instruction for disrupting the wireless connection established between the access point device and the client device; and
one or more third codes for formatting one or more connection requests, each of the one or more connection requests including the wireless MAC address of the client device as originator identity and the wireless MAC address of the access point device as destination identity;
a processor module comprising one or more micro processing devices, the processor module being for executing at least the first one or more codes, the second one or more codes, and the third one or more codes; and
a transmitter module including one or more wireless communication transmitting interfaces for transmitting the one or more connection requests to disrupt the wireless connection established between the access point device and the client device.
